(19) United States
(12) Patent Application Publication
(10) Pub. No.: US 2026/0012350 A1
(43) Pub. Date: Jan. 8, 2026

(54) CROSS TRUSTED AUTHORITIES IDENTITY AUTHENTICATION AND MESSAGE PUBLISHING METHOD BASED ON REDACTABLE BLOCKCHAIN

(71) Applicant: Hangzhou Normal University, Hangzhou (CN)

(72) Inventors: Qi Xie, Hangzhou (CN); Zhengyang Sun, Hangzhou (CN); Bin Hu, Hangzhou (CN); Xiao Tan, Hangzhou (CN); Lidong Han, Hangzhou (CN); Shengbao Wang, Hangzhou (CN); Yining Liu, Hangzhou (CN); Anjia Yang, Hangzhou (CN)

(21) Appl. No.: 18/946,921

(22) Filed: Nov. 14, 2024

(30) Foreign Application Priority Data
Jul. 4, 2024 (CN) 202410891910.7

(51) Int. Cl. H04L 9/32; H04L 9/30

(52) U.S. Cl. CPC H04L 9/3231; H04L 9/3066; H04L 9/3297

(57) ABSTRACT

The invention discloses a cross trusted authority identity authentication and message publishing method based on redactable blockchain, adopts a redactable blockchain based on chameleon hash function to replace the traditional blockchain, and the trusted authority can use the private key of the chameleon hash function to edit the block content on the blockchain, so that only legal, valid and timely information is stored on the blockchain. In addition, the trusted authority can also edit the vehicle authentication information stored on the blockchain, easily updating the vehicle information credentials or revoking the information credentials of illegal vehicles. In the process of authentication and key negotiation, cryptography tools are used to ensure the confidentiality, integrity and availability of messages, and can effectively resist various known attacks.

### TECHNICAL FIELD

The invention belongs to the technical field of information security, and in particular relates to a method for identity authentication and message publishing across trusted authorities based on a redactable blockchain.

### BACKGROUND

With the development of intelligent transportation systems, there is an increasing demand for communication between vehicles and between vehicle and infrastructure. However, these communications are at risk of being tampered with and forged. Therefore, ensuring the reliability and security of communication has become an urgent problem to be solved. Most of the existing solutions rely on a single trusted authority, which has a single point of failure and security risks. The emergence of redactable blockchain technology provides a new way to solve the above problems.

### SUMMARY

The purpose of the invention is to provide a cross-trusted authority identity authentication and message publishing method based on a redactable blockchain, aiming to address the issues present in current existing solutions.

To achieve the above purposes, the invention provides a cross-trusted authority authentication and message publishing method based on a redactable blockchain, including the following steps: A redactable blockchain-based approach to cross trusted authority authentication and message publishing that is characterized by including the following steps:
S1. Based on elliptic curve cryptography, all trusted authorities choose their private keys and corresponding public keys, and jointly maintain the redactable blockchain and deploy smart contracts on the blockchain for identity authentication, key negotiation and parameter updating of vehicles;
S2. The vehicle and roadside unit RSU submit a registration request to the trusted authority, which feedback the registration information to the vehicle and the roadside unit, and stores the registration information of the vehicle and the roadside unit in the on-board unit OBU of the vehicle and the storage unit of the roadside unit, respectively;
S3. When the vehicle passes through the RSU for the first time or the vehicle validity period is about to expire, the RSU authenticates the vehicle's identity based on the blockchain, and sends the information to the trusted authority after the successful authentication, the trusted authority updates the vehicle's authentication information on the blockchain, and gives a certain period of validity, and returns the information to the RSU. The trusted authority updates the vehicle's authentication information on the blockchain, and the RSU passes the updated information to the vehicle after receiving the message, and negotiates the session key with the vehicle to update the locally stored authentication parameters;
S4. After receiving traffic information from other vehicles, the vehicle accesses the blockchain to obtain the authentication information of the other vehicle and verify the validity and integrity of the message sent by the other vehicle.
S2 is specifically:
S2.1 Vehicle Vᵢ choose identity IDᵢ and sends it to TA, TA first verify the IDᵢ is unique and valid, then chooses the random number xᵢ, and computes A_{V}=Eₛₖ_{_{TA}} (IDᵢ∥xᵢ). TA chooses chameleon hash public and private keys pki and ski for Vᵢ, and random number rᵢ₁, computes H_{V}=ch_hashₚₖᵢ(A_{V}, rᵢ₁), rᵢ₂=ch_cldₛₖᵢ(A_{V}, rᵢ₁, M), where Mis publicly available vehicle information. According to the properties of the chameleon hash, it has H_{V}=ch_hashₚₖᵢ(A_{V}, rᵢ₁)=ch_hashₚₖᵢ(M, rᵢ₂); TA stores {H_{V}, M, pki, A_{V}, rᵢ₁, IDᵢ} on an redactable blockchain, where {A_{V}, rᵢ₁, IDᵢ} are private parameter; TA sends {M, rᵢ₂, pki, ski} to Vᵢ through secure channel; Vᵢ stores {M, rᵢ₂, pki, ski} in onboard unit (OBU) of vehicle;
S2.2 After Vᵢ receiving the message, user enters biometric information bioᵢ, OBU computes (αᵢ, βᵢ)=Gen(bioᵢ), chooses PUF challenge chaᵢ, and computes resᵢ=PUF(chaᵢ), B_{V}=h(IDᵢ∥αᵢ∥resᵢ)mod n, C_{V}=Eᵣₑₛ_{ᵢ}(rᵢ₂∥ski), where n∈(2⁴, 2⁸); Vᵢ stores {B_{V}, C_{V}, βᵢ, M, pki, chaᵢ} in OBU;
S2.3 TA chooses identity RIDⱼ for RSUⱼ, set private key of RSUⱼ is skⱼ=h(sk_{TA}∥RIDⱼ), the corresponding public key is calculated as pkⱼ=skⱼ·P; TA sends {RIDⱼ, skⱼ} to RSUⱼ through secure channel;
S2.4 After receiving the message, RSUⱼ chooses PUF challenge chaⱼ, and computes resⱼ=PUF(chaⱼ), Kⱼ=resⱼ⊕skⱼ, RSUⱼ stores {RIDⱼ, Kⱼ, chaⱼ} in its memory.

According to the redactable blockchain-based cross trusted authority authentication and message publishing method described in claim 1, which is characterized by the S3 specifically:
S3.1 User inputs identity

$${ID}_{i}^{*}$$

and biometric information

$${bio}_{i}^{*}$$

in OBU; OBU computes

$${α}_{i}^{*} = Rep ( {bio}_{i}^{*} , {β}_{i} ) , {res}_{i}^{*} = PUF ( {cha}_{i} ) , {B}_{V}^{*} = h ( {ID}_{i}^{*} \vert \vert {α}_{i}^{*} \vert \vert {res}_{i}^{*} ) , if {B}_{V}^{*} \neq {B}_{V} ,$$

OBU rejects the login request of the user, otherwise the user login succeeds;
S3.2 Vehicle Vᵢ generates a random number mᵢ and timestamp t₁, and computes (rᵢ₂∥ski)=Dᵣₑₛ_{ᵢ}(C_{V}) to recover parameters rᵢ₂ and ski, computes M₁=mᵢ·P, M₂=rᵢ₂⊕h(mᵢ·pkⱼ∥t₁), M₃=h(rᵢ₂∥M∥M₁∥M₂∥t₁), where M is a vehicle information certificate composed of relevant publicly available information; Vᵢ sends MSG₁={M, M₁, M₂, M₃, t₁} to RSU via a common channel;
S3.3 The current time

$${t}_{1}^{*}$$

is generated after the message is received, the timestamp t₁ is verified by formula

$$\vert {t}_{1}^{*} - {t}_{1} \vert \leq Δ T .$$

Then RSUⱼ calculates resⱼ=PUF(chaⱼ), skⱼ=resⱼ⊕Kⱼ, and computes

$${r}_{i 2}^{′} = {M}_{2} ⊕ h ( {sk}_{j} \cdot {M}_{1} \vert \vert {t}_{1} ) , {M}_{3}^{′} = h ( {r}_{i 2}^{′} \vert \vert M \vert \vert {M}_{1} \vert \vert {M}_{2} \vert \vert {t}_{1} ) ; If {M}_{3}^{′} \neq {M}_{3} ,$$

RSUⱼ terminates the session; otherwise, RSUⱼ gets H_{V}, pki from the blockchain according to M and computes

$${H}_{V}^{′} = {ch\_hash}_{pki} ( M , {r}_{i 2}^{′} ) ; If {H}_{V}^{′} \neq {H}_{V} ,$$

RSUⱼ discards this information and terminates the session, otherwise, creates timestamp t₂ and computes M₄=h(skⱼ∥M∥M₁∥t₂); RSUⱼ packages MSG₂={RIDⱼ, M, M₄, t₂} and invokes the smart contract on the blockchain, sends data to the smart contract via an open channel;
S3.4 The smart contract on the blockchain first generates the current timestamp

$${t}_{2}^{*}$$

after receiving the message, the timestamp t₂ is verified by formula

$$\vert {t}_{2}^{*} - {t}_{2} \vert \leq Δ T ;$$

Then computes skⱼ=h(sk_{TA}∥RIDⱼ),

$${M}_{4}^{′} = h ( {sk}_{j} \vert \vert M \vert \vert {M}_{1} \vert \vert {t}_{2} ) , if {M}_{4}^{′} \neq {M}_{4} ,$$

the request is denied; After verification, TA generates a new vehicle information certificate M*, timestamp t₃, computes M₅=Eₛₖ_{ⱼ}(skⱼ∥M*∥t₃), and sends {M₅, t₃} to RSUⱼ through open channel; Finally, TA uses the private key sk_{ch} corresponding to the chameleon hash function on the blockchain and new certificate M* updates old certificate M;
S3.5 After RSUⱼ receiving the message from the blockchain, the current timestamp

$${t}_{3}^{*}$$

is generated, the timestamp t₃ is verified by formula

$$\vert {t}_{3}^{*} - {t}_{3} \vert \leq Δ T ;$$

computes (skⱼ∥M*∥t₃)=Dₛₖ_{ⱼ}(skⱼ∥M*∥t₃), chooses random number nⱼ, timestamp t₄, computes N₁=nⱼ·P, session key SKⱼ=h(nⱼ·M₁∥M₁∥N₁∥M*), N₂=h(SKⱼ∥N₁∥t₄), and sends {N₁, N₂, M*, t₄} to Vᵢ;
S3.6 After vehicle Vᵢ receiving the message, it generates the current timestamp

$${t}_{4}^{*} ,$$

the timestamp t₄ is verified by formula

$$\vert {t}_{4}^{*} - {t}_{4} \vert \leq Δ T ;$$

and then Vᵢ computes session key SKᵢ=h(mᵢ·N₁∥M₁∥N₁∥M*), and

$${N}_{2}^{′} = h ( {SK}_{i} \vert \vert {N}_{1} \vert \vert {t}_{4} ) , if {N}_{2}^{′} \neq {N}_{2} ,$$

the request is denied; If verified, Vᵢ computes

$${r}_{i 2}^{*} = {ch\_cld}_{ski} ( {r}_{i 2} , M , {M}^{*} ) ,$$

and replaced {M, rᵢ₂} with

$$\{ {M}^{*} , {r}_{i 2}^{*} \} ;$$

At this point, authentication, key negotiation, and parameter updates are completed.

The method of cross trusted authority authentication and message publishing based on redactable blockchain described in claim 3 is characterized by the method of verifying time stamps, specifically

$$\vert {t}_{n}^{*} - {t}_{n} \vert \leq Δ T ,$$

where tₙ is the timestamp contained in the message sent in the previous stage,

$${t}_{n}^{*}$$

is the current timestamp obtained by the device when the message was received, ΔT indicates the threshold time allowed in the communication process. When the time difference is greater than the threshold time, the authentication is terminated. When the time difference is less than the threshold value, go to the next step.

According to the redactable blockchain-based cross-trusted authority authentication and message publishing method described in Claim 4, which is characterized by said S4, specifically:
S4.1 User inputs identity

$${ID}_{i}^{*}$$

and biometric information

$${bio}_{i}^{*}$$

in Vᵢ's OBU; OBU computes

$${α}_{i}^{*} = Rep ( {bio}_{i}^{*} , {β}_{i} ) , {res}_{i}^{*} = PUF ( {cha}_{i} ) , {B}_{V}^{*} = h ( {ID}_{i}^{*} \vert \vert {α}_{i}^{*} \vert \vert {res}_{i}^{*} ) mod n , if {B}_{V}^{*} \neq {B}_{V} ,$$

OBU rejects the user's login request, otherwise the user logs in successfully; Vᵢ computes (rᵢ₂∥ski)=Dᵣₑₛ_{ᵢ}(C_{V}) to recover parameter; Vᵢ generate timestamp t₁ and information to be sent to other vehicles m and computes rᵢ₃=ch_cldₛₖᵢ(M, rᵢ₂, m), M₃=h(rᵢ₃∥M∥m∥t₁); Then Vᵢ sends MSG₁={M, rᵢ₃, m, t₁, M₃} to Vⱼ via open channel;
S4.2 After vehicle Vⱼ receiving the message, it verifies the timestamp t₁ by the formula

$$\vert {t}_{1}^{*} - {t}_{1} \vert \leq Δ T ,$$

and then computes

$${M}_{3}^{′} = h ( {r}_{i 3} \vert \vert M \vert \vert m \vert \vert {t}_{1} ) ; if {M}_{3}^{′} \neq {M}_{3} ,$$

discards the message; otherwise, Vⱼ gets H_{V}, pki from blockchain by M, and computes

$${H}_{V}^{′} = {ch\_hash}_{pki} ( m , {r}_{i 3} ) ,$$

if

$${H}_{V}^{′} \neq {H}_{V} ,$$

the message is discarded to end the session. Otherwise, the message successfully passes the verification of integrity and validity.

According to claim 5, a redactable blockchain-based method of identity authentication and message distribution across trusted authorities is characterized by the fact that the MSG₁, MSG₂, MSG₃ and MSG₄ are transmitted within a common channel.

The redactable blockchain-based cross trusted authority authentication and messaging method described in claim 1 is characterized by the fact that the method also includes the tracking and tagging of malicious vehicles, specifically:
When a malicious vehicle Vᵢ is found, smart contracts acquire vehicle information A_{V} stored on the blockchain; and by computing (IDᵢ∥xᵢ)=Dₛₖ_{_{TA}}(A_{V}) and obtains the true identity of the vehicle Vᵢ;
Assume that the block where the vehicle information resides is X, the corresponding random number is R₁. The TA of the location of the vehicle generates a new block content X* that will be marked as a malicious vehicle Vᵢ, computes ch_cldₛₖ_{_{ch}}(X, R₁, X*)=R₂; Guarantee that if the block hash value is unchanged, replace the context X with X*.

The technical effect of the invention is:
1. Replace the original hash function in the blockchain with a chameleon hash function, making the blockchain redactable. All trusted authorities that maintain the blockchain have the right to read and write the blockchain and can modify the blockchain;
2. The vehicle can communicate with the roadside unit only, obtain updated identity credentials on the blockchain itself, and update local parameters;
3. Pay attention to the privacy protection of vehicles, the true identity of vehicles can only be obtained by the vehicle itself and the trusted authority, and the vehicle will not expose its true identity in the process of interacting with other entities;
4. Integrate PUFs and biometric keys into the roadside unit and OBUs to resist the roadside unit capture attack and OBU intrusion attack;
5. Elliptic curve cryptosystem has the advantages of short key, high strength, few parameters, fast digital signature, small amount of calculated data, etc., especially suitable for devices with limited computing resources and storage resources.

### BRIEF DESCRIPTION OF DRAWINGS

The accompanying drawings, which form a part of this application, are used to provide further understanding of the present application. The illustrative embodiments and their explanations of the present application are used to explain the present application and do not constitute undue limitation of the present application. In the accompanying picture:

FIG. 1 is a system model diagram between the vehicle, the roadside unit and the redactable blockchain in the embodiment of the invention;

FIG. 2 is a flow chart of mutual authentication and session key negotiation between vehicle and blockchain in embodiments of the invention;

FIG. 3 is a flow chart of message authentication between vehicles in embodiments of the invention.

### DETAILED DESCRIPTION OF EMBODIMENTS

It should be noted that the embodiments in this application and the features in the embodiments may be combined with each other, provided that there is no conflict. This application is described in detail below with reference to the attached drawings and in conjunction with embodiments.

It should be noted that the steps illustrated in the attached process can be executed in a computer system such as a set of computer-executable instructions, and, although the logical sequence is shown in the flow diagram, in some cases the steps shown or described can be executed in a different order than is shown here.

The purpose of the invention is to provide a cross trusted authority authentication and message publishing method based on a redactable blockchain. To solve the problem of vehicle cross-domain authentication in the current Internet of vehicles scenario and the inability to delete expired and illegal data on the blockchain, make use of the distributed characteristics of the traditional blockchain, so that the trusted authority in different regions can jointly supervise the vehicle information stored on the blockchain; Using the characteristics of redactable blockchain, entities with redactable permissions can edit the blockchain to ensure the validity and legitimacy of the data on the blockchain.

The invention provides a cross-trusted authority identity authentication and message release method based on redactable block chain. When the vehicle passes the roadside unit for the first time on the road or the validity period of the vehicle is about to expire, the roadside unit authenticates the vehicle based on the block chain and sends information to the trusted authority after successful authentication, which updates the vehicle's authentication information on the block chain. And give a certain period of validity, and negotiate the session key with the vehicle to facilitate subsequent communication. After the trusted authority updates the vehicle's authentication information on the blockchain, the vehicle can access the blockchain, update the locally stored authentication parameters, and calculate the session key. Different vehicles can communicate traffic information to each other. After receiving traffic information from other vehicles, the vehicle can verify the validity and integrity of the message sent by the other vehicle by accessing the blockchain to obtain the authentication information of the other vehicle.

Vehicles have their own credentials on the blockchain. Vehicles can communicate only with roadside units, obtain updated credentials on the blockchain themselves, and update local parameters. The validity of messages sent between vehicles can also be verified via blockchain. By introducing elliptic curve cryptography to encrypt key parameters in the authentication process, the security of the whole authentication process is improved.

It includes the following steps:
S1 All trusted authorities choose elliptic curve E(GF_{q}), biological information generation algorithm Gen(⋅), the recovery algorithm Rep(⋅). a secure hash function h(⋅), ch_hash(⋅) is the chameleon hash function, ch_cld(⋅) is Hash collision function, their private keys sk_{TA}, and compute corresponding public keyspk_{TA}=sk_{TA}·P. All trusted authorities jointly maintain the redactable blockchain, and the chameleon hashes public-private key pairs sk_{ch} and pk_{ch} on the blockchain, smart contracts are deployed on the blockchain for vehicle identity authentication, key negotiation, and parameter updating.
S2 The vehicle and roadside unit RSU submits a registration request to the trusted authority, which feedback the registration information to the vehicle and the roadside unit, and stores the registration information of the vehicle and the roadside unit in the on-board unit OBU of the vehicle and the storage unit of the roadside unit, respectively, S2 is specifically:
S2.1, vehicle Vᵢ choose identity IDᵢ and sends it to TA, TA first verifies the IDᵢ is unique and valid, then chooses the random number xᵢ, and computes A_{V}=Eₛₖ_{_{TA}} (IDᵢ∥xᵢ). TA chooses chameleon hash public and private keys pki and ski for Vᵢ, and random number rᵢ₁, computes H_{V}=ch_hashₚₖᵢ(A_{V}, rᵢ₁), rᵢ₂=ch_cldₛₖᵢ(A_{V}, rᵢ₁, M), where M is publicly available vehicle information. According to the properties of the chameleon hash, it has H_{V}=ch_hashₚₖᵢ(A_{V}, rᵢ₁)=ch_hashₚₖᵢ(M, rᵢ₂); TA stores {H_{V}, M, pki, A_{V}, rᵢ₁, IDᵢ} on an redactable blockchain, where {A_{V}, rᵢ₁, IDᵢ} are private parameters; TA sends {M, rᵢ₂, pki, ski} to Vᵢ through a secure channel; Vᵢ stores {M, rᵢ₂, pki, ski} in OBU;
S2.2, After Vᵢ receiving the message, user enters biometric information bioᵢ, OBU computes (αᵢ, βᵢ)=Gen(bioᵢ), choose PUF challenge chaᵢ, and computes resᵢ=PUF(chaᵢ), B_{V}=h(IDᵢ∥αᵢ∥resᵢ) mod n, C_{V}=Eᵣₑₛ_{ᵢ}(rᵢ₂∥ski), where n∈(2⁴, 2⁸); Vᵢ stores {β_{V}, C_{V}, βᵢ, M, pki, chaᵢ} in OBU;
S2.3, TA choose identity RIDⱼ for RSUⱼ, set RSUⱼ private key is skⱼ=h(sk_{TA}∥RIDⱼ), the corresponding public key is calculated as pkⱼ=skⱼ·P; TA sends {RIDⱼ, skⱼ} to RSU through secure channel;
S2.4, After receiving the message, RSUⱼ chooses PUF challenge chaⱼ, and computes resⱼ=PUF(chaⱼ), Kⱼ=resⱼ⊕skⱼ, RSUⱼ stores {RIDⱼ, Kⱼ, chaⱼ} in its memory;
When the vehicle passes through the RSU for the first time or the vehicle validity period is about to expire, the RSU authenticates the vehicle's identity based on the blockchain, and sends the information to the trusted authority after the successful authentication, the trusted authority updates the vehicle's authentication information on the blockchain, and gives a certain period of validity, and returns the information to the RSU. The trusted authority updates the vehicle's authentication information on the blockchain, and the RSU passes the updated information to the vehicle after receiving the message, and negotiates the session key with the vehicle to update the locally stored authentication parameters:
S3.1, User inputs identity

$${ID}_{i}^{*}$$

and biometric information

$${bio}_{i}^{*}$$

in OBU; OBU computes

$${α}_{i}^{*} = Rep ( {bio}_{i}^{*} , {β}_{i} ) , {res}_{i}^{*} = PUF ( {cha}_{i} ) , {B}_{V}^{*} = h ( {ID}_{i}^{*} \vert \vert {α}_{i}^{*} \vert \vert {res}_{i}^{*} ) , if {B}_{V}^{*} \neq {B}_{V} ,$$

OBU rejects the login request of the user, otherwise the user login succeeds;
S3.2, Vehicle Vᵢ generates a random number mᵢ and timestamp t₁, and computes (rᵢ₂∥ski)=Dᵣₑₛ_{ᵢ}(C_{V}) to recover parameters rᵢ₂ and ski; it computes M₁=mᵢ·P, M₂=rᵢ₂⊕h(mᵢ·pkⱼ∥t₁), M₃=h(rᵢ₂∥M∥M₁∥M₂∥t₁), where M is a vehicle information certificate composed of relevant publicly available information; Vᵢ sends MSG₁={M, M₁, M₂, M₃, t₁} to RSUⱼ via a common channel;
S3.3, The current time

$${t}_{1}^{*}$$

is generated after the message is received, the timestamp t₁ is verified by formula

$$\vert {t}_{1}^{*} - {t}_{1} \vert \leq Δ T .$$

Then RSUⱼ calculates resⱼ=PUF(chaⱼ), skⱼ=resⱼ⊕Kⱼ, and computes

$${r}_{i 2}^{′} = {M}_{2} ⊕ h ( {sk}_{j} \cdot {M}_{1} \vert \vert {t}_{1} ) , {M}_{3}^{′} = h ( {r}_{i 2}^{′} \vert \vert M \vert \vert {M}_{1} \vert \vert {M}_{2} \vert \vert {t}_{1} ) ; If {M}_{3}^{′} \neq {M}_{3} ,$$

RSUⱼ terminates the session; otherwise, RSUⱼ gets H_{V}, pki from the blockchain according to M and computes

$${H}_{V}^{′} = {ch\_hash}_{pki} ( M , {r}_{i 2}^{′} ) ; If {H}_{V}^{′} \neq {H}_{V} ,$$

RSUⱼ discards this information and terminates the session, otherwise, creates timestamp t₂ and computes M₄=h(skⱼ∥M∥M₁∥t₂); RSUⱼ packages MSG₂={RIDⱼ, M, M₄, t₂} and invokes the smart contract on the blockchain, sends data to the smart contract via an open channel;
S3.4 The smart contract on the blockchain first generates the current timestamp

$${t}_{2}^{*}$$

after receiving the message, the timestamp t₂ is verified by formula

$$\vert {t}_{2}^{*} - {t}_{2} \vert \leq Δ T ;$$

Then computes skⱼ=h(sk_{TA}∥RIDⱼ),

$${M}_{4}^{′} = h ( {sk}_{j} ‖ M ‖ {M}_{1} ‖ {t}_{2} ) , if {M}_{4}^{′} \neq {M}_{4} ,$$

the request is denied; After verification, TA generates a new vehicle information certificate M*, timestamp t₃, computes M₅=Eₛₖ_{ⱼ}(skⱼ∥M*∥t₃), and sends {M₅, t₃} to RSUⱼ through open channel; Finally, TA uses the private key sk_{ch} corresponding to the chameleon hash function on the blockchain and new certificate M* updates old certificate M;
S3.5 After RSUⱼ receiving the message from the blockchain, the current timestamp

$${t}_{3}^{*}$$

is generated, the timestamp t₃ is verified by formula

$$\vert {t}_{3}^{*} - {t}_{3} \vert \leq Δ T ;$$

computes (skⱼ∥M*∥t₃)=Dₛₖ_{ⱼ}(skⱼ∥M*∥t₃), chooses random number nⱼ, timestamp t₄, computes N₁=nⱼ·P, session key SKⱼ=h(nⱼ·M₁∥M₁∥N₁∥M*), N₂=h(SKⱼ∥N₁∥t₄), and sends {N₁, N₂, M*, t₄} to Vᵢ;
S3.6, After vehicle Vᵢ receiving the message, it generates the current timestamp

$${t}_{4}^{*} ,$$

the timestamp t₄ is verified by formula

$$\vert {t}_{4}^{*} - {t}_{4} \vert \leq Δ T ;$$

and then Vᵢ computes session key SKᵢ=h(mᵢ·N₁∥M₁∥N₁∥M*), and

$${N}_{2}^{′} = h ( {SK}_{i} ‖ {N}_{1} ‖ {t}_{4} ) , if {N}_{2}^{′} \neq {N}_{2} ,$$

the request is denied; If verified, Vᵢ computes

$${r}_{i 2}^{*} = {ch\_cld}_{ski} ( {r}_{i 2} , M , {M}^{*} ) ,$$

and replaces {M, rᵢ₂} with

$$\{ {M}^{*} , {r}_{i 2}^{*} \} ;$$

At this point, authentication, key negotiation, and parameter updates are completed.

After receiving traffic information from other vehicles, the vehicle accesses the blockchain to obtain the authentication information of the other vehicle and verify the validity and integrity of the message sent by the other vehicle:
S4.1, User inputs identity

$${ID}_{i}^{*}$$

and biometric information

$${bio}_{i}^{*}$$

in Vᵢ's OBU; OBU computes

$${α}_{i}^{*} = Rep ( {bio}_{i}^{*} , {β}_{i} ) , {res}_{i}^{*} = PUF ( {cha}_{i} ) , \\ {B}_{V}^{*} = h ( {ID}_{i}^{*} ‖ {α}_{i}^{*} ‖ {res}_{i}^{*} ) mod n , if {B}_{V}^{*} \neq {B}_{V} ,$$

OBU rejects the user's login request, otherwise the user logs in successfully; Vᵢ computes (rᵢ₂∥ski)=Dᵣₑₛ_{ᵢ}(C_{V}), generates timestamp t₁ and information to be sent to other vehicles m and computes rᵢ₃=ch_cldₛₖᵢ(M, rᵢ₂, m), M₃=h(rᵢ₃∥M∥m∥t₁); Then Vᵢ sends MSG₁={M, rᵢ₃, m, t₁, M₃} to Vⱼ via open channel;
S4.2, After vehicle Vⱼ receiving the message, it verifies the timestamp t₁ by the formula

$$\vert {t}_{1}^{*} - {t}_{1} \vert \leq Δ T ,$$

and then computes

$${M}_{3}^{′} = h ( {r}_{i 3} \vert \vert M \vert \vert m \vert \vert {t}_{1} ) ; if {M}_{3}^{′} \neq {M}_{3} ,$$

discards the message; otherwise, Vⱼ gets H_{V}, pki from blockchain by M, and computes

$${H}_{V}^{′} = {ch\_hash}_{pki} ( m , {r}_{i 3} ) , if {H}_{V}^{′} \neq {H}_{V} ,$$

the message is discarded to end the session. Otherwise, the message successfully passes the verification of integrity and validity.
S5 Although the identity of the vehicle is anonymous, it is still possible to track the true identity of the malicious vehicle if needed, specifically:
S5.1 When a malicious vehicle Vᵢ is found, smart contracts acquire vehicle information A_{V} stored on the blockchain; and by computing (IDᵢ∥xᵢ)=Dₛₖ_{_{TA}}(A_{V}), and obtains the true identity of the vehicle Vᵢ;
S5.2 Assume that the block where the vehicle information resides is X, the corresponding random number is R₁. The TA of the location of the vehicle generates a new block content X* that will be marked as a malicious vehicle Vᵢ, computes ch_cldₛₖ_{_{ch}}(X, R₁, X*)=R₂; Guarantee that if the block hash value is unchanged, replace the context X with X*.

The method of cross trusted authority authentication and message publishing based on redactable blockchain described in claim 3 is characterized by the method of verifying time stamps, specifically

$$\vert {t}_{n}^{*} - {t}_{n} \vert \leq Δ T ,$$

where tₙ is the timestamp contained in the message sent in the previous stage,

$${t}_{n}^{*}$$

is the current timestamp obtained by the device when the message was received, ΔT indicates the threshold time allowed in the communication process. When the time difference is greater than the threshold time, the authentication is terminated. When the time difference is less than the threshold value, go to the next step.

The MSG₁, MSG₂, MSG₃ and MSG₄ are transmitted within a common channel.

Table 1 shows the symbols used in this invention:

TABLE 1

| Symbol | description |
|---|---|
| Vᵢ | Vehicle i |
| RSUⱼ | Road side unit j |
| IDᵢ | Unique identity of Vᵢ |
| bioᵢ | The user's biometric information |
| RIDⱼ | Unique identity of RSUⱼ |
| SK | Session key |
| sk_{TA}, pk_{TA} | Public-private key pair of TA |
| sk_{ch}, pk_{ch} | Public-private key pair of chameleon hash function on |
| | blockchain |
| skⱼ, pkⱼ | Public-private key pair of RSUⱼ |
| ski, pki | Vᵢ public-private key pair of chameleon hash function |
| chaⱼ, resⱼ | PUF challenge and response of RSUⱼ |
| t₁, t₂, t₃ | timestamp |
| h(.) | Hash function |
| ch_hash(.) | Chameleon hash generating function |
| ch_cld(.) | Chameleon hash collision function |
| ∥ | connector |
| ⊕ | Xor operation |
| P | Base point of an elliptic curve |
| Rep(.), | Functions used for recovery and generation in fuzzy |
| Gen(.) | extraction algorithms |
| αᵢ, βᵢ | Biometric keys and reproduction parameters of fuzzy |
| | extractor algorithm |
| Δt | Transmission delay time |

### Embodiment I

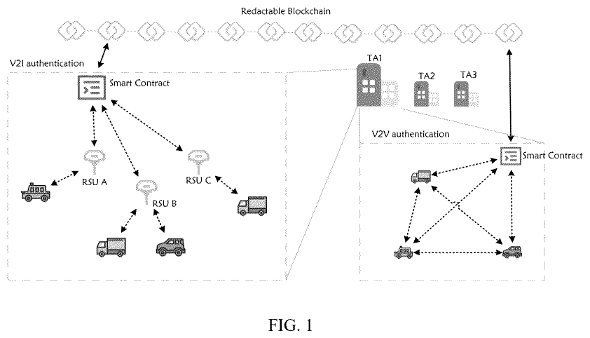

As shown in FIG. 1, a cross-trusted authority authentication and message publishing method based on redactable blockchains is implemented based on vehicles, roadside units, and redactable blockchain-based tripartite entities. The on-board unit of the vehicle and the storage unit of the roadside unit store information, and the vehicle and roadside unit are first registered in the trust authority. All trusted authorities jointly maintain the redactable blockchain and have the right to read and write the blockchain, that is, the trusted authority has the threshold of the chameleon hash function on the blockchain, and can modify the information stored on the blockchain.

When the vehicle passes the roadside unit or the validity period of the vehicle is about to expire, it communicates with the roadside unit. The roadside unit authenticates the vehicle's identity based on the blockchain, and sends information to the trusted authority after successful authentication. The trusted authority updates the vehicle's authentication information on the blockchain, gives a certain period of validity, and negotiates the session key with the vehicle for subsequent communication. After the trusted authority updates the vehicle's authentication information on the blockchain, the vehicle can access the blockchain, update the locally stored authentication parameters, and calculate the session key. Different vehicles can communicate traffic information to each other. After receiving traffic information from other vehicles, the vehicle can verify the validity and integrity of the message sent by the other vehicle by accessing the blockchain to obtain the authentication information of the other vehicle.

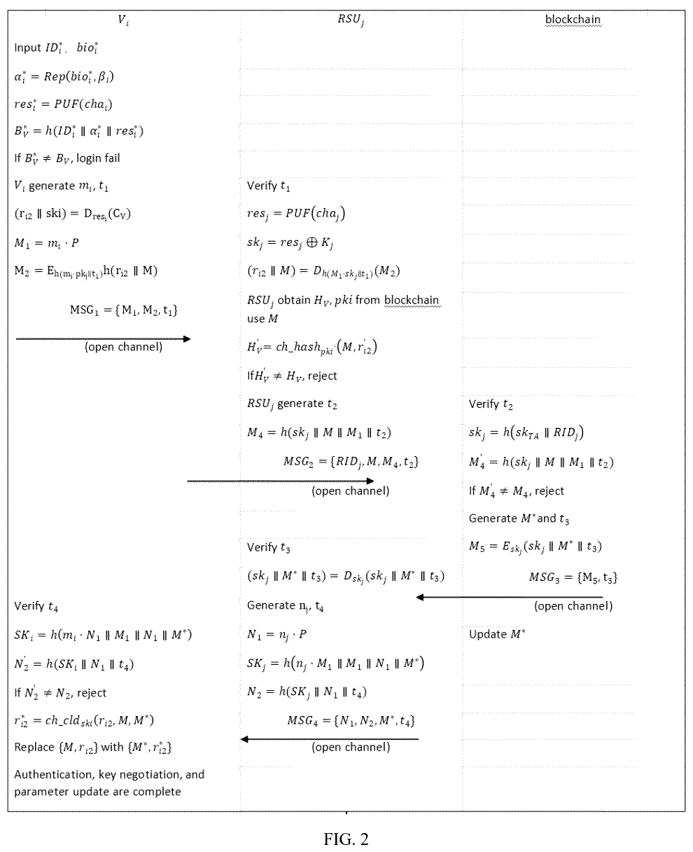

As shown in FIG. 2, the process of mutual authentication and session key negotiation between the vehicle and the blockchain is as follows:

Communicate with the roadside unit when the vehicle passes the roadside unit or when the vehicle validity period is about to expire. The driver of the vehicle Vᵢ enters his biometric information, if the biological information is verified, the driver's identity authentication is successful; otherwise, the vehicle Vᵢ requires the driver to re-certify. Vᵢ generates authentication parameters and sends them to the roadside unit RSUⱼ. First, the blockchain is used to verify the legitimacy and integrity of the vehicle's authentication parameters, and then the smart contract on the blockchain is called to pass some of the parameters to the blockchain. The redactable blockchain verifies the message and updates the vehicle's authentication parameters. Vᵢ can access the blockchain to obtain the newly generated authentication parameters and store them locally.

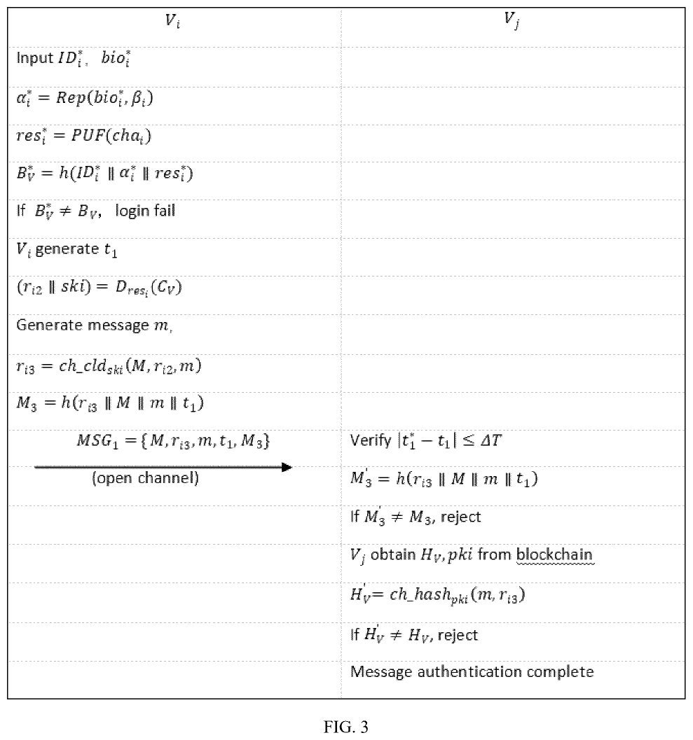

As shown in FIG. 3, the process of message authentication between Vᵢ and Vⱼ is as follows:

Vehicle Vᵢ generates the message to be sent, use the chameleon hash function to generate the corresponding authentication parameters, and then sends the message to the vehicle Vⱼ. After Vⱼ receiving the message, the relevant information of the vehicle Vᵢ is obtained by accessing the blockchain and the legitimacy and integrity of the message is verified. If the verification is passed, the message is accepted, otherwise the message is rejected.

The above is only the best concrete implementation of this application, but the scope of protection of this application is not limited to this, any technical personnel familiar with the technical field in the technical scope disclosed in this application, can easily think of changes or replacements, should be covered by the scope of protection of this application. Therefore, the scope of protection in this application should be governed by the scope of protection claimed.

What is claimed is:

1. A method for identity authentication and message publishing across trusted authorities based on a redactable blockchain, its features include the following steps:
Based on elliptic curve, a public/private key pair is set for each trusted authority of choice, and its corresponding public key is established; all trusted authorities jointly maintain an editable blockchain, and smart contracts are deployed on the blockchain for vehicle identity authentication, key negotiation, and parameter updates;
The vehicle and roadside unit RSU submit a registration request to the trusted authority, which feedback the registration information to the vehicle and the roadside unit, and stores the registration information of the vehicle and the roadside unit in the on-board unit OBU of the vehicle and the storage unit of the roadside unit, respectively;
When the vehicle passes through the RSU for the first time or the vehicle validity period is about to expire, the RSU authenticates the vehicle's identity based on the blockchain, and sends the information to the trusted authority after the successful authentication, the trusted authority updates the vehicle's authentication information on the blockchain, and gives a certain period of validity, and returns the information to the RSU, The trusted authority updates the vehicle's authentication information on the blockchain, and the RSU passes the updated information to the vehicle after receiving the message, and negotiates the session key with the vehicle to update the locally stored authentication parameters;
After receiving traffic information from other vehicles, the vehicle accesses the blockchain to obtain the authentication information of the other vehicle and verify the validity and integrity of the message sent by the other vehicle.

2. According to a method for identity authentication and message publishing across trusted authorities based on a redactable blockchain in claim 1, S2 specifically comprises:
S2.1, vehicle Vᵢ choose identity IDᵢ and sends it to TA, TA first verify the IDᵢ is unique and valid, then chooses the random number xᵢ, and computes A_{V}=Eₛₖ_{_{TA}} (IDᵢ∥xᵢ), TA chooses chameleon hash public and private keys pki and ski for Vᵢ, and random number rᵢ₁, computes H_{V}=ch_hashₚₖᵢ(A_{V}, rᵢ₁), rᵢ₂=ch_cldₛₖᵢ(A_{V}, rᵢ₁, M), where M is publicly available vehicle information, According to the properties of the chameleon hash, it has H_{V}=ch_hashₚₖᵢ(A_{V}, rᵢ₁)=ch_hashₚₖᵢ(M, rᵢ₂); TA stores {H_{V}, M, pki, A_{V}, rᵢ₁, IDᵢ} on an redactable blockchain, where {A_{V}, rᵢ₁, IDᵢ} are private parameter; TA sends {M, rᵢ₂, pki, ski} to Vᵢ through secure channel; Vᵢ stores {M, rᵢ₂, pki, ski} in onboard unit (OBU) of vehicle;
S2.2, after Vᵢ receiving the message, user enters biometric information bioᵢ, OBU computes (αᵢ, βᵢ)=Gen(bioᵢ), chooses PUF challenge chaᵢ, and computes resᵢ=PUF(chaᵢ), B_{V}=h(IDᵢ∥αᵢ∥resᵢ) mod n, C_{V}=Eᵣₑₛ_{ₒ}(rᵢ₂∥ski), where n∈(2⁴, 2⁸); Vᵢ stores {B_{V}, C_{V}, βᵢ, M, pki, chaᵢ} in OBU;
S2.3, TA chooses identity RIDⱼ for RSUⱼ, set private key of RSUⱼ is skⱼ=h(sk_{TA}∥RIDⱼ), the corresponding public key is calculated as pkⱼ=skⱼ·P; TA sends {RIDⱼ, skⱼ} to RSUⱼ through secure channel;
S2.4, After receiving the message, RSUⱼ chooses PUF challenge chaⱼ, and computes resⱼ=PUF(chaⱼ), Kⱼ=resⱼ ⊕skⱼ, RSUⱼ stores {RIDⱼ, Kⱼ, chaⱼ} in its memory.

3. According to the redactable blockchain-based cross trusted authority authentication and message publishing method described in claim 1, S3 specifically comprises:
S3.1, User inputs identity
$${ID}_{i}^{*}$$
and biometric information bioᵢ* in OBU; OBU computes
$${α}_{i}^{*} = Rep ( {bio}_{i}^{*} , {β}_{i} ) , {res}_{i}^{*} = PUF ( {cha}_{i} ) , {B}_{V}^{*} = h ( {ID}_{i}^{*} \vert \vert {α}_{i}^{*} \vert \vert {res}_{i}^{*} ) , if {B}_{V}^{*} \neq {B}_{V} ,$$
OBU rejects the login request of the user, otherwise the user login succeeds;
S3.2, Vehicle Vᵢ generates a random number mᵢ and timestamp t₁, and computes (rᵢ₂∥ski)=Dᵣₑₛ_{ᵢ}(C_{V}) to recover parameters rᵢ₂ and ski, computes M₁=mᵢ·P, M₂=rᵢ₂⊕h(mᵢ·pkⱼ∥t₁), M₃=h(rᵢ₂∥M∥M₁∥M₂∥t₁), where M is a vehicle information certificate composed of relevant publicly available information; Vᵢ sends MSG₁={M, M₁, M₂, M₃, t₁} to RSUⱼ via a common channel;
S3.3, The current time
$${t}_{1}^{*}$$
is generated after the message is received, the timestamp t₁ is verified by formula
$$\vert {t}_{1}^{*} - {t}_{1} \vert \leq Δ T .$$
The RSUⱼ calculates resⱼ=PUF(chaⱼ), skⱼ=resⱼ⊕Kⱼ, and computes
$${r}_{i 2}^{′} = {M}_{2} ⊕ h ( {sk}_{j} \cdot {M}_{1} \vert \vert {t}_{1} ) , {M}_{3}^{′} = h ( {r}_{i 2}^{′} \vert \vert M \vert \vert {M}_{1} \vert \vert {M}_{2} \vert \vert {t}_{1} ) ; If {M}_{3}^{′} \neq {M}_{3} ,$$
RSUⱼ terminates the session; otherwise, RSUⱼ gets H_{V}, pki from the blockchain according to M and computes
$${H}_{V}^{′} = {ch\_hash}_{pki} ( M , {r}_{i 2}^{′} ) ; If {H}_{V}^{′} \neq {H}_{V} ,$$
RSUⱼ discards this information and terminates the session, otherwise, creates timestamp t₂ and computes M₄=h(skⱼ∥M∥M₁∥t₂); RSUⱼ packages MSG₂={RIDⱼ, M, M₄, t₂} and invokes the smart contract on the blockchain, sends data to the smart contract via an open channel;
S3.4, The smart contract on the blockchain first generates the current timestamp
$${t}_{2}^{*}$$
after receiving the message, the timestamp t₂ is verified by formula
$$\vert {t}_{2}^{*} - {t}_{2} \vert \leq Δ T ;$$
Then computes skⱼ=h(sk_{TA}∥RIDⱼ),
$${M}_{4}^{′} = h ( {sk}_{j} \vert \vert M \vert \vert {M}_{1} \vert \vert {t}_{2} ) , if {M}_{4}^{′} \neq {M}_{4} ,$$
the request is denied; After verification, TA generates a new vehicle information certificate M*, timestamp t₃, computes M₅=Eₛₖ_{ⱼ}skⱼ∥M*∥t₃), and sends {M₅, t₃} to RSUⱼ through open channel; Finally, TA uses the private key sk_{ch} corresponding to the chameleon hash function on the blockchain and new certificate M* updates old certificate M;
S3.5, After RSU receiving the message from the blockchain, the current timestamp
$${t}_{3}^{*}$$
is generated, the timestamp t₃ is verified by formula
$$\vert {t}_{3}^{*} - {t}_{3} \vert \leq Δ T ;$$
computes (skⱼ∥M*|t₃)=Dₛₖ_{ⱼ}(skⱼ∥M*∥t₃), chooses random number nⱼ, timestamp t₄, computes N₁=nⱼ·P, session key SKⱼ=h(nⱼ·M₁∥M₁∥N₁∥M*), N₂=h(SKⱼ∥N₁∥t₄), and sends {N₁, N₂, M*, t₄} to Vᵢ;
S3.6, After vehicle Vᵢ receiving the message, it generates the current timestamp
$${t}_{4}^{*} ,$$
the timestamp t₄ is verified by formula
$$\vert {t}_{4}^{*} - {t}_{4} \vert \leq Δ T ;$$
and then computes session key SKᵢ=h(mᵢ·N₁∥M₁∥N₁∥M*), and
$${N}_{2}^{′} = h ( {SK}_{i} \vert \vert {N}_{1} \vert \vert {t}_{4} ) , if {N}_{2}^{′} \neq {N}_{2} ,$$
the request is denied; If verified, Vᵢ computes
$${r}_{i 2}^{*} = {ch\_cld}_{ski} ( {r}_{i 2} , M , {M}^{*} ) ,$$
and replaces {M, rᵢ₂} with
$$\{ {M}^{*} , {r}_{i 2}^{*} \} ;$$
At this point, authentication, key negotiation, and parameter updates are completed.

4. The method of cross trusted authority authentication and message publishing based on redactable blockchain described in claim 3 is characterized by the method of verifying time stamps, specifically
$$\vert {t}_{n}^{*} - {t}_{n} \vert \leq Δ T ,$$
where tₙ is the timestamp contained in the message sent in the previous stage,
$${t}_{n}^{*}$$
is the current timestamp obtained by the device when the message was received, ΔT indicates the threshold time allowed in the communication process, When the time difference is greater than the threshold time, the authentication is terminated, When the time difference is less than the threshold value, go to the next step.

5. According to the redactable blockchain-based cross-trusted authority authentication and message publishing method described in claim 4, S4 specifically comprises:
S4.1, User inputs identity
$${ID}_{i}^{*}$$
and biometric information
$${bio}_{i}^{*}$$
in
$${V}_{i}^{′} s$$
OBU; OBU computes
$${α}_{i}^{*} = ( {bio}_{i}^{*} , {β}_{i} ) , {res}_{i}^{*} = PUF ( {cha}_{i} ) , {B}_{V}^{*} = h ( {ID}_{i}^{*} \vert \vert {α}_{i}^{*} \vert \vert {res}_{i}^{*} ) mod n , if {B}_{V}^{*} \neq {B}_{V} ,$$
OBU rejects the user's login request, otherwise the user logs in successfully; Vᵢ computes (rᵢ₂∥ski)=Dᵣₑₛ_{ᵢ}(C_{V}) to recover parameter; Vᵢ generate timestamp t₁ and information to be sent to other vehicles m and computes rᵢ₃=ch_cldₛₖᵢ(M, rᵢ₂, m), M₃=h(rᵢ₃∥M∥m∥t₁); Then Vᵢ sends MSG₁={M, rᵢ₃, m, t₁, M₃} to Vⱼ via open channel;
S4.2, After vehicle Vⱼ receiving the message, it verifies the timestamp t₁ by the formula
$$\vert {t}_{1}^{*} - {t}_{1} \vert \leq Δ T ,$$
and then computes
$${M}_{3}^{′} = h ( {r}_{i 3} \vert \vert M \vert \vert m \vert \vert {t}_{1} ) ; if {M}_{3}^{′} \neq {M}_{3} ,$$
discards the message; otherwise, Vⱼ gets H_{V}, pki from blockchain by M, and computes
$${H}_{V}^{′} = {ch\_hash}_{pki} ( m , {r}_{i 3} ) ,$$
if
$${H}_{V}^{′} \neq {H}_{V} ,$$
the message is discarded to end the session, Otherwise, the message successfully passes the verification of integrity and validity.

6. According to claim 5, a redactable blockchain-based method of identity authentication and message distribution across trusted authorities is characterized by the fact that the MSG₁, MSG₂, MSG₃ and MSG₄ are transmitted within a common channel.

7. The redactable blockchain-based cross trusted authority authentication and messaging method described in claim 1 is characterized by the fact that the method also includes the tracking and tagging of malicious vehicles, specifically:
When a malicious vehicle Vᵢ is found, smart contracts acquire vehicle information A_{V} stored on the blockchain; and by computing (IDᵢ∥xᵢ)=Dₛₖ_{_{TA}}(A_{V}) and obtains the true identity of the vehicle Vᵢ;
Assume that the block where the vehicle information resides is X, the corresponding random number is R₁. The TA of the location of the vehicle generates a new block content X* that will be marked as a malicious vehicle Vᵢ, computes ch_cldₛₖ_{_{ch}}(X, R₁, X*)=R₂; Guarantee that if the block hash value is unchanged, replace the context X with X*.
